(19) United States
(12) Patent Application Publication
(10) Pub. No.: US 2016/0283933 A1
(43) Pub. Date: Sep. 29, 2016

(54) SYSTEMS AND METHODS FOR PROVIDING AN INTERNET OF THINGS PAYMENT PLATFORM (IOTPP)

(71) Applicant: Fit Pay, Inc., Danville, CA (US)

(72) Inventors: Michael Joseph ORLANDO, Danville, CA (US); Scott Carlos STEVELINCK, Lyons, CO (US); Christopher Paul ORLANDO, San Marcos, CA (US)

(21) Appl. No.: 15/081,576

(22) Filed: Mar. 25, 2016

Related U.S. Application Data
(60) Provisional application No. 62/312,922, filed on Mar. 24, 2016.
(60) Provisional application No. 62/138,298, filed on Mar. 25, 2015.

(51) Int. Cl. G06Q 20/32; G06Q 20/40; G06Q 20/38

(52) U.S. Cl. CPC G06Q 20/3224; G06Q 20/382; G06Q 20/40

(57) ABSTRACT

Systems and methods are provided for processing electronic payment from a portable device that is associated with a user to a payment network via a merchant device and a gateway. The gateway can be notified when the user is in a merchant's premises. For example, the gateway can receive a token associated with the user's portable device and then use this token to retrieve the user's profile. The gateway can also receive a payment request initiated by the user, and in response, authenticate the user based on the user's profile, process the payment request, and notify the merchant if the payment is approved. During the payment process, the user advantageously does not need to share his or her personal or financial information at the point of sale in the merchant's premises.

### RELATED APPLICATIONS

This application claims priority to, and incorporates by reference in its entirety, the following applications: U.S. Provisional Patent Application No. 62/138,298, titled “Internet of Things Payment Platform (IoTPP),” which was filed on Mar. 25, 2015; and U.S. Provisional Patent Application No. 62/312,922, titled “Internet of Things Payment Platform (IoTPP),” which was filed on Mar. 24, 2016.

### BACKGROUND OF THE INVENTION

1. Technical Field

The invention relates generally to the field of systems and methods for providing an Internet of Things (IoT) Payment Platform (IoTPP).

2. Description of the Related Art

Retail point of sale (POS) transactions are currently conducted through three primary systems: (1) credit or debit card-based legacy systems that use magnetic swipe technology and require a customer signature or personal identification number (PIN) to verify and validate a transaction; (2) Near Field Communication (NFC) based systems through which the credit or debit card information is transmitted by tapping the card on or near a POS terminal; and (3) mobile platforms that use mobile device-based applications that require the presence of a mobile device, the launching of an application, scanning a code, entering a PIN or other form of authentication, and confirmation. There are, however, several primary problems, limitations, and/or disadvantages associated with each of the existing systems, processes, and approaches to conducting retail transactions.

First, because some of the existing platforms require consumers to share their credit or debit information at the point of sale, they are vulnerable to security breaches. For example, recent high-profile breaches of customer information have occurred primarily through malware that was placed on existing or legacy POS terminals. It has been reported that some malwares have already unknowingly infected more than a thousand retailers.

Second, the existing platforms require a high level of consumer action, whether that includes signing a screen with a stylus, opening a mobile application, or touching a device to a screen or sensor. These required actions result in a loss of consumer convenience and denigrate the overall service level of the consumer retail transaction.

Third, the existing systems use a limited range of methods to validate a consumer's identity. For example, traditional credit or debit cards require a customer signature, which is only referenced if a particular transaction is questioned. New chip technology within plastic payment cards can enhance security by adding the requirement of a PIN. These systems, however, are only as secure as an individual consumer's PIN, which can be lost, stolen, or replicated. More recent entrants into the mobile payment market have added fingerprint recognition as a validation method. These systems can be time consuming for a consumer to authenticate and have high incidences of false positives.

Fourth, the existing systems require the consumers to carry their payment tools such as wallet, payment card, or smartphone with them in order to pay at the POS. This may cause their payment tools to be lost or breached.

Fifth, the existing systems have limited capability to service “on-demand” offers and/or loyalty programs. Traditional POS service locations cannot identify the consumers until the consumers provide them with some variables to connect their identities to the purchase history and preferences. Usually it would be too late for merchants to tailor the consumers' in-store experience to their preferences.

Therefore, there is a need in the art to provide systems and methods for improving payment transaction systems. Accordingly, it is desirable to provide methods and systems that overcome these and other deficiencies of the related art.

### SUMMARY

In accordance with the disclosed subject matter, systems, methods, and computer readable media are provided for an Internet of Things (IoT) Payment Platform (IoTPP).

Disclosed subject matter includes, in one aspect, a method for electronic payment from a portable device that is associated with a user to a payment network via a merchant device and a gateway. The method includes receiving, at the gateway from the merchant device, a first message that includes information indicating that the portable device that is associated with the user is within a predefined distance from the merchant device, a token received from the portable device, and location information of the merchant device; retrieving, at the gateway, a profile of the user based on the token received from the portable device, where the user's profile includes a picture of the user; sending, at the gateway to the merchant device, a second message that includes information indicating that the user is within the predefined distance from the merchant device, and the picture of the user for authentication; receiving, at the gateway from the merchant device, a payment request that is associated with the user; determining, at the gateway, if an identity of the user can be authenticated based on the user's profile and at least one of the location information or the payment request; and when the user's identity can be authenticated: (1) determining, at the gateway, a payment form for the payment request that is determined based on the user's profile and the payment request, (2) sending, at the gateway to the payment network, the payment form, (3) receiving, at the gateway from the payment network, a payment authorization, and (4) sending, at the gateway to the merchant device, the payment authorization.

Disclosed subject matter includes, in another aspect, an apparatus for facilitating electronic payment from a portable device that is associated with a user to a payment network via a merchant device and the apparatus. The apparatus includes a memory and a processor. The memory stores a module. The processor is configured to run the module stored in the memory that is configured to cause the processor to do the following steps. The processor receives, from the merchant device, a first message that includes information indicating that the portable device that is associated with the user is within a predefined distance from the merchant device, a token received from the portable device, and location information of the merchant device. The processor retrieves a profile of the user based on the token received from the portable device, where the user's profile includes a picture of the user. The processor sends, to the merchant device, a second message that includes information indicating that the user is within the predefined distance from the merchant device, and the picture of the user for authentication. The processor receives, from the merchant device, a payment request that is associated with the user The processor determines if an identity of the user can be authenticated based on the user's profile and at least one of the location information or the payment request. When the user's identity can be authenticated, the processor (1) determines a payment form for the payment request that is determined based on the user's profile and the payment request; (2) sends, to the payment network, the payment form; (3) receives, from the payment network, a payment authorization; and (4) sends, to the merchant device, the payment authorization.

Disclosed subject matter includes, in yet another aspect, a computer readable medium for electronic payment. The non-transitory computer readable medium includes executable instructions operable to cause an apparatus to first device to receive, from a merchant device, a first message that comprises information indicating that a portable device that is associated with a user is within a predefined distance from the merchant device, a token received from the portable device, and location information of the merchant device. The instructions are further operable to cause the apparatus to retrieve a profile of the user based on the token received from the portable device, where the user's profile comprises a picture of the user. The instructions are further operable to cause the apparatus to send, to the merchant device, a second message that comprises information indicating that the user is within the predefined distance from the merchant device, and the picture of the user for authentication. The instructions are further operable to cause the apparatus to receive, from the merchant device, a payment request that is associated with the user. The instructions are further operable to cause the apparatus to determine if an identity of the user can be authenticated based on the user's profile and at least one of the location information or the payment request. When the user's identity can be authenticated, the instructions are further operable to cause the first device to determine a payment form for the payment request that is determined based on the user's profile and the payment request; send, to a payment network, the payment form; receive, from the payment network, a payment authorization; and send, to the merchant device, the payment authorization.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be made to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a system for electronic payment in accordance with certain embodiments of the disclosed subject matter.

FIG. 2 illustrates a user onboarding process in accordance with certain embodiments of the disclosed subject matter.

FIG. 3 illustrates a “push” process for proximity detection and payment in accordance with certain embodiments of the disclosed subject matter.

FIG. 4 illustrates a “pull” process for proximity detection and payment in accordance with certain embodiments of the disclosed subject matter.

FIG. 5 illustrates a detection and authentication flow for electronic payment in accordance with an embodiment of the disclosed subject matter.

FIG. 6 illustrates a connected persona algorithm (CPA) used to detect, identify, and authenticate IoTPP users in accordance with certain embodiments of the disclosed subject matter.

FIG. 7 shows an authentication and transaction process of electronic payment through the CPA in accordance with an embodiment of the disclosed subject matter.

FIG. 8 illustrates a block diagram of a gateway in accordance with certain embodiments of the disclosed subject matter.

FIGS. 9A-9B show a flow chart illustrating a process of electronic payment in accordance with certain embodiments of the disclosed subject matter.

### DETAILED DESCRIPTION

In the following description, numerous specific details are set forth regarding the systems, methods and media of the disclosed subject matter and the environment in which such systems, methods and media may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems, methods, and media that are within the scope of the disclosed subject matter.

The present invention is directed to an Internet of Things Payment Platform (also referred to as IoTPP, FitPay, FitPay Platform, or Platform), which combines a unique customer identity validation process, proximity technology-based location verification, and/or a cloud-based payment exchange that does not require personal and/or sensitive financial (e.g., credit or debit card, bank account) information to be shared at the point of sale (POS).

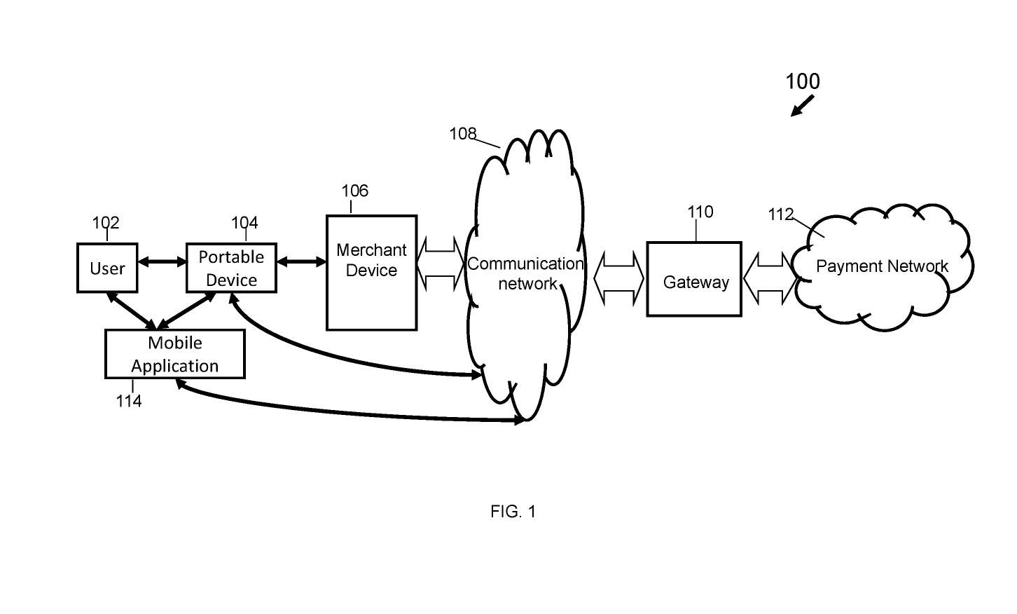

FIG. 1 illustrates a diagram of a system 100 for electronic payment from a portable device that is associated with a user to a payment network via a merchant device and a gateway in accordance with certain embodiments of the disclosed subject matter. The system 100 can include at least one user 102, at least one portable device 104, a merchant device 106, a communication network 108, a gateway 110, a payment network 112, and a mobile application 114. Some or all components of the system 100 can be coupled directly or indirectly to a communication network 108. The components included in the system 100 can be further broken down into more than one component and/or combined together in any suitable arrangement. Further, one or more components can be rearranged, changed, added, and/or removed. For example, in some embodiments, the mobile application 114 is not a required component.

Each portable device 104 is generally paired with a user 102. In some embodiments, the portable device 104 can determine whether or not the user 102 is an authenticated user through a PIN or password entered by the user 102. In some embodiments, the portable device 104 can authenticate the user 102 through physiological patterns such as fingerprint, heartbeat, vein recognition, or any other suitable physiological pattern or combination of physiological patterns. In some embodiments, the portable device 104 can authenticate the user 104 via the mobile application 114. The portable device 104 can also be referred to as an Internet of Things (IoT) device or an authorized authentication device (AAD). The authentication process is explained in more detail below.

In some embodiments, the portable device 104 can include one or more displays and/or illumination such as screens (including touch screens), LEDs, E Ink displays, backlights, and/or any other suitable display. The one or more displays can be in color and/or in black-and-white. In some embodiments, the portable device 104 can include one or more sensors such as a GPS module, an accelerometers, a gyroscope, a compass, an optical heart rate monitor, an altimeter, an ambient light sensor, a vibration motor, or a smart clasp that can detect whether a suitable portable device 104, such as a wristband, is in a clasped position. Any other suitable sensor or combination of suitable sensors can be used.

The portable device 104 can have one or more communication modules such as wireless transceivers. The communication module enables bidirectional communication between the portable device 104 and other portable devices 104 and/or the merchant device 106 via any suitable wireless connection including, without limitation, Bluetooth (including Bluetooth Low Energy (BLE)), NFC, WiFi, cellular, and/or other communication standards. In some embodiments, the communication module can also enable bi-directional communication between the portable device 104 and other portable devices 104, the merchant device 106, the gateway 110, the payment network 112, and/or any other suitable component of the system 100 via the communication network 108. In some embodiments, the portable device 104 can advertise its presence through BLE or any other suitable communication technology. In some embodiments, the communication technology provides a communication layer between the portable device 104 and the merchant device 106. In some embodiments, the communication technology also facilitates customized content to be delivered to the user's mobile application 114.

The portable device 104 can be a wearable device such as a smart watch, a fitness band, a FitPay proprietary device, or any other suitable device including a piece of jewelry such as a brooch or charm or necklace. In some embodiments, the portable device 104 can also include a laptop computer, a tablet computer, a cellular device including a smartphone, or any other suitable device.

The mobile application 114 can be associated with a mobile device possessed by the user 102. The mobile device can be smartphones, tablets, laptops, or any other suitable device. The mobile application 114 allows the user 102 to securely create, edit, and delete his or her user's profile and account. An account created by the user 102 is also referred to as an IoTPP account. As a non-limiting example, the user 102 can establish the following user preferences.

A first user preference can include payment types. This feature allows the user 102 to add a variety of credit card, bank, gift cards or other payment accounts to his or her user's profile and create preferences that define which form of payment the user 102 chooses to use under various scenarios. Preferences can include specific payment account by transaction amount, by specific merchant or merchant type (e.g., quick-serve restaurant, casual dining, and gas station).

A second user preference can include a payment and location/merchant combination. This feature allows the user 102 to define payment type/location and payment type/merchant combinations that establish which forms of payment the user prefers to use at which geographic location or with which merchant. A user may choose to use the flexible saving account (FSA) benefits debit cards at pharmacy locations but primary bank account debit card for purchases at all other locations.

A third user preference can include a payment waterfall. This feature allows the user 102 to define the specific order of payment forms within a “payment waterfall.” A payment waterfall can be assigned to a group of payment accounts where the user 102 desires to use certain accounts prior to using other accounts. This feature is useful for payment by gift card where the gift card has priority over debit or credit cards registered by the user. As an example, a user may have received a $5 gift card to Jamba Coffee. When his or her IoTPP account is activated at a Jamba Coffee location for a purchase amount of $8.56, the gift card is depleted prior to the remaining payment being posted his debit card.

A forth user preference can include gratuity. This feature allows the user 102 to set a standard gratuity level for restaurant and other service-oriented merchant locations. For example, within a user's configuration preferences, a default gratuity percentage of 15% or other percentage can be set for all casual dining locations. As another example, a fixed amount of $3 or other dollar amount can be set for transactions in the amount less than $10.

In some embodiments, the user 102 does not have to use the mobile application 114 to manage his or her account and/or user's profile. For example, the user 102 can log on to a dedicated website and manage his or her account and/or user's profile.

The merchant device 106 can serve at least two functions. First, the merchant device 106 can detect the presence of the portable device 104 through the wireless signals emitted by the portable device 104 and communicate with the gateway 110 regarding the presence of the portable device. In some embodiments, the detection can be triggered when the portable device 104 is within a predefined distance from the merchant device 106. In some embodiments, the predefined distance can be 1 foot, 10 feet, 20 feet, or any other suitable distance, via any other suitable metric, that is supported by the underlying wireless communication protocol. In some embodiments, the predefined distance can have a customized value such that the merchant device 106 can detect the presence of the portable device 104 when the portable device 104 is within the premises of the merchant. In some embodiments, the merchant device 106 can also send the gateway 110 a token received from the portable device 104. In some embodiments, the token can be any suitable indication of the portable device 104 and/or the user 102. For example, the token can be a digital fingerprint such as the portable device 104's media access control (MAC) address, the Internet Protocol (IP) address, a BLE profile such as a BLE signature or a BLE serial number, and/or other suitable identifier or combination of identifiers that can identify the portable device 104. In some embodiments, the merchant device 106 also sends location information of the merchant device 106 and/or the portable device 104 to the gateway 110.

Second, the merchant device 106 can also serve as a POS terminal so that the user 102 can initiate a payment request at the merchant device 106, and the merchant device 106 can send the payment request to the gateway 110. In some embodiments, the merchant device 106 includes a proximity detection device (PDD) and a POS terminal. The PDD can detect the presence of the portable device 104 through the wireless signals emitted by the portable device 104 and communicate with the gateway 110 regarding the presence of the portable device 104, and the POS terminal can receive the user 102's payment request and send the payment request to the gateway 110. In some embodiments, the PDD and the POS terminal are separate devices. In some embodiments, the PDD and the POS terminal are integrated into a single device.

The gateway 110 can store and update a profile of the user 102. The user's profile can include one or more of the following information regarding the user 102: a profile picture, a payment preference, transaction history, location history, merchant history (for example, the merchant(s) the user 102 has dealt with), social media activity, purchase behavior, fitness data, biometric data, and/or any other suitable data. The gateway 110 can store the user's profile at a local storage system and/or a remote/cloud storage system. In some embodiments, the user's profile can also be additionally stored at the portable device 104. The gateway 110 can also communicate, directly or indirectly, with other components of the system 100. For example, the gateway 110 can authenticate the portable device 104 when the gateway 110 receives a message, from the merchant device 104, that includes information indicating that the portable device 104 associated with the user 102 is within a predefined distance from the merchant device 106. The structure and function of the gateway 110 are explained in more detail below.

The communication network 108 can accommodate public, private, an/or encrypted data communication. For example, the communication network 108 can include a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. Such networks may be implemented with any number of hardware and software components, transmission media and network protocols. FIG. 1 shows the communication network 108 as a single network; however, the communication network 108 can include multiple interconnected networks listed above.

The payment network 112 serves as a clearinghouse for the payment transaction processing. In some embodiment, the payment network 112 can also provide detailed reporting, reconciliation, and/or notification to the user 102 and/or the merchants. In some embodiments, certain functions of the payment network 112 can also be implemented by the gateway 110.

In some embodiments, the gateway 110 and/or the payment network 112 can be coupled to a network storage system. The network storage system can include two types of network storage devices: a local network storage medium and a remote network storage medium. The local network storage medium and the remote network storage medium can each include at least one physical, non-transitory storage medium, flash memory, a magnetic disk drive, an optical drive, a programmable read-only memory (PROM), a read-only memory (ROM), or any other memory or combination of memories. The local network storage medium and the remote network storage medium can be part of the gateway 110 and/or the payment network 112 or can be separated from the gateway 110 and/or the payment network 112.

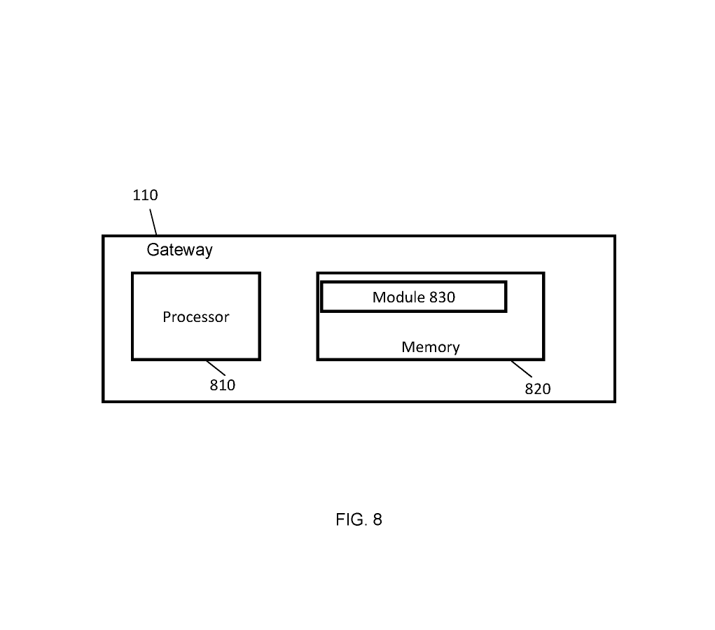

FIG. 8 is a block diagram of the gateway 110 in accordance with some embodiments of the disclosed subject matter. The gateway 110 includes a processor 810 and a memory 820. The memory 820 includes a module 830. The gateway 110 may include additional modules, fewer modules, or any other suitable combination of modules that perform any suitable operation or combination of operations.

In some embodiments, the processor 810 can include one or more cores and can accommodate one or more threads to run various applications and modules. The software can run on the processor 810 capable of executing computer instructions or computer code. The processor 810 might also be implemented in hardware using an application specific integrated circuit (ASIC), programmable logic array (PLA), field programmable gate array (FPGA), or any other integrated circuit.

The memory 820 can be a non-transitory computer readable medium, flash memory, a magnetic disk drive, an optical drive, a PROM, a ROM, or any other memory or combination of memories.

The processor 810 can be configured to run the module 830 stored in the memory 820 that is configured to cause the processor 810 to perform various steps that are discussed throughout the disclosed subject matter. For example, the module 830 can be configured to cause the processor 810 of the gateway 110 to receive, from the merchant device 106, a first message that includes information indicating that the portable device 104 that is associated with the user 102 is within a predefined distance from the merchant device 106, a token received from the portable device 104, and location information of the merchant device 104. The module 830 can be configured to cause the processor 810 to retrieve a profile of the user 102 based on the token received from the portable device 104, where the user's profile includes a picture of the user 102. The module 830 can be configured to cause the processor 810 to send, to the merchant device 106, a second message that includes information indicating that the user 102 is within the predefined distance from the merchant device 106, and the picture of the user 102 for authentication. The module 830 can be configured to cause the processor 810 to receive, from the merchant device 106, a payment request that is associated with the user 102. The module 830 can be configured to cause the processor 810 to determine if an identity of the user 102 can be authenticated based on the user's profile and at least one of the location information or the payment request. When the user's identity can be authenticated, the module 830 can be configured to cause the processor 810 to (1) determine a payment form for the payment request that is determined based on the user's profile and the payment request; (2) send, to the payment network 112, the payment form; (3) receive, from the payment network 112, a payment authorization; and (4) send, to the merchant device 106, the payment authorization.

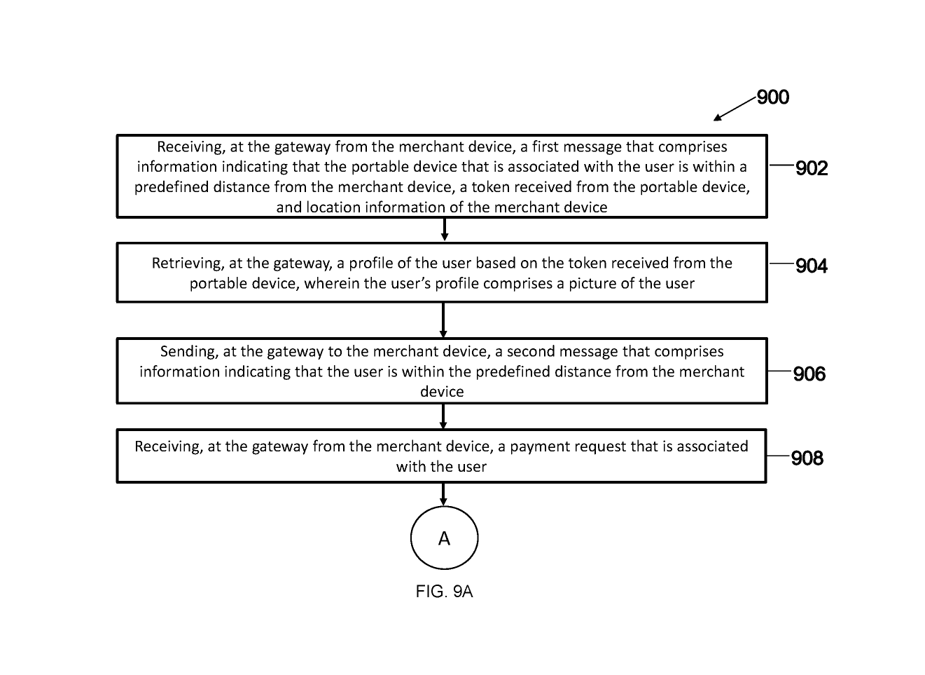

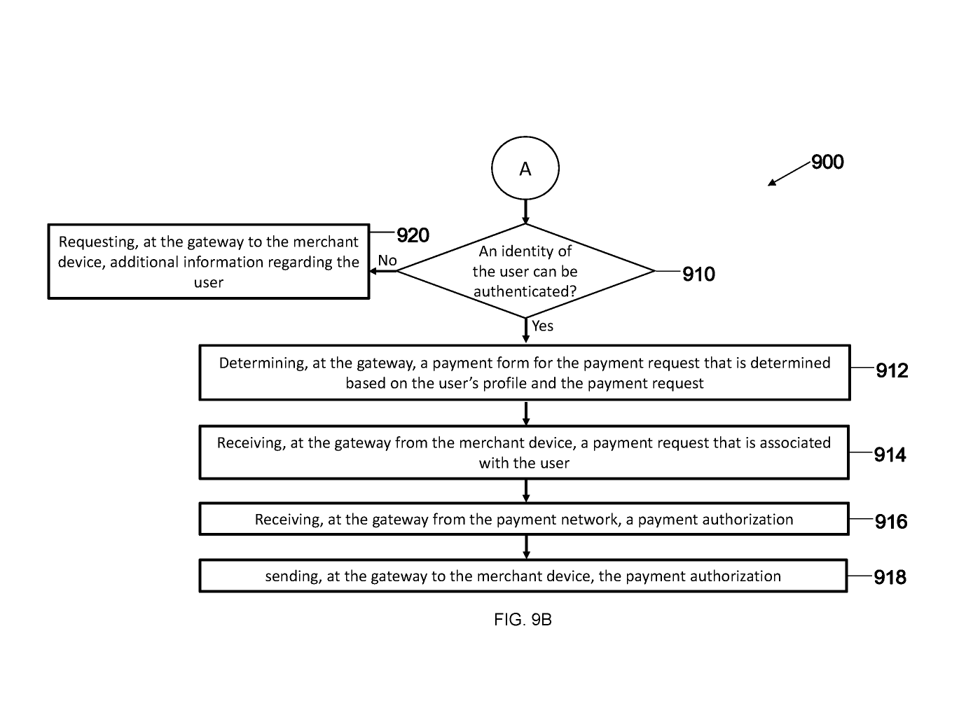

FIGS. 9A and 9B show a flow chart illustrating a process 900 of electronic payment from the portable device 104 that is associated with the user 102 to the payment network 112 via the merchant device 106 and the gateway 110 in accordance with certain embodiments of the disclosed subject matter. In some embodiments, the process 900 can be modified by, for example, having steps combined, divided, rearranged, changed, added, and/or removed.

At step 902, the gateway 110 receives, from the merchant device 106, a first message that includes information indicating that the portable device 104 that is associated with the user 102 is within a predefined distance from the merchant device 106, a token received from the portable device 102, and location information of the merchant device 106.

As a non-limiting use case example that illustrates the process 900, at step 902, the user 102 with a portable device 104 visits a coffee store. The portable device 104 can be a fitness band or other wearable devices, a smartphone, a computer, a tablet, a BLE accessory, other IoT devices, and/or any other suitable device. The portable device 104 can emit wireless signals, such as BLE signals, so that the merchant device 106 in the coffee store can detect the presence of the portable device 104. In some embodiments, the detection can be triggered when the portable device 104 is within a predefined distance from the merchant device 106. In some embodiments, the predefined distance can be 1 foot, 10 feet, 20 feet, or any other suitable distance, via any other suitable metric, that is supported by the underlying wireless communication protocol. For example, the merchant device 106 can locate at a POS terminal so that the POS terminal can detect the presence of the portable device 104 (and the user 102) when the portable device 104 is within the predefined distance from the POS terminal. In some embodiments, the predefined distance can have a customized value such that the merchant device 106 can detect the presence of the portable device 104 when the portable device 104 is within the premise of the merchant. For example, the merchant device 106 can include a PDD at the entrance of the coffee shop so that the merchant device 106 can detect the presence of the portable device 104 once it is in or near the premises of the coffee shop. Once the merchant device 106 detects that the user 102 is at the coffee shop, it can send a first message to the gateway 110 indicating the user 102's presence. The first message also includes a token received from the portable device 104 and the location information of the merchant device 106 (or the general location information of the coffee shop). In some embodiments, the token can be a digital fingerprint that identifies the portable device 104. For example, the digital fingerprint can be the portable device 104's MAC address, the IP address, a BLE profile such as a BLE signature or a BLE serial number, and/or other suitable identifiers or combination of identifiers that can identify the portable device 104. The process 900 then proceeds to step 904.

At step 904, the gateway 110 retrieves a profile of the user 102 based on the token received from the portable device 104. The user's profile is created by the user 102 when he or she first uses the payment system disclosed in the present application. The user 102 can manage his or her user's profile through a dedicated mobile application 114 or through a website. The user's profile can include one or more of the following categories of information: the user's profile picture, the user's payment preference, the user's transaction history, the user's location history, the user's social media activity, the history of the merchants that the user has dealt with, the user's purchase behavior, the user's fitness data, the user's biometric data, and/or any other suitable information. The categories of the user's profile are not mutually exclusive, and one category of information can include information from other categories. The process 900 then proceeds to step 906.

At step 906, the gateway 110 sends a second message to the merchant device 106. The merchant device 106 includes information indicating that the user 102 is within the predefined distance from the merchant device 106, and the profile picture of the user 102 for authentication. For example, in the use case example, the gateway 110 can notify the merchant device 106 that the user 102 is in the coffee shop. In some embodiments, the gateway 110 can also send some or all of the user's profile to the merchant device 106. For example, based on the user's profile such as the profile picture received at the merchant device 106, an employee of the coffee shop can greet the user 102. Further, based on the user's purchase behavior, the employee can ask whether the user 102 wants a particular kind of coffee. The process 900 then proceeds to step 908.

At step 908, the gateway 110 receives, from the merchant device 106, a payment request that is associated with the user 102. For example, in the use case example, the user 102 may tell the employee that he or she wants a cappuccino. The user 102 generally does not need to show his or her identification because the merchant device 106 has received a token from the user 102's portable device 104, and therefore can identify, directly or via the gateway 110, the portable device 104 and the user 102 associated with the portable device 104. Similarly, the user 102 generally does not need to show a payment card or cash, because the gateway 110 has already retrieved the user's profile that includes one or more payment accounts associated with user 102. The process 900 then proceeds to step 910.

At step 910, the gateway 110 determines if an identity of the user 102 can be authenticated based on the user's profile and at least one of the location information or the payment request. For example, if the user's profile indicates that the user 102 has visited the coffee shop before, and the location information sent by the merchant device 106 indicates that the location is that coffee shop, then in some cases the gateway 110 will determine that it is a factor that is in favor of authenticating the user 102. On the other hand, if the user's profile shows that the user 102 has never visited the coffee shop indicated by the location information, then in some cases the gateway 110 will determine that it is a factor that is not in favor of authenticating the user 102. Similarly, if the payment request shows that the user 102 purchases a cappuccino, and the user's profile indicates that the user 102 has purchased a cappuccino before, then in some cases the gateway 110 will determine that it is a factor that is in favor of authenticating the user 102. On the other hand, if the payment request shows that the user 102 purchases a cappuccino, and the user's profile indicates that the user 102 has never purchased a cappuccino before, then in some cases the gateway 110 will determine that it is a factor that is not in favor of authenticating the user 102. In some embodiments, the gateway 110 can consider other factors to determine whether or not the user 102 is an authenticated user. For example, if the user's profile suggests that the user 102 always purchases a coffee in the early morning, a payment request indicating the user 102 purchases a coffee in the late afternoon may be considered to be a factor that is not in favor of authenticating the user 102. In some embodiments, the gateway 110 can dynamically set a threshold of authentication. For example, if the payment request is associated with a low value commodity and/or service, the gateway 110 may determine that the user 102 is an authenticated user as long as there is at least one factor that is in favor of the user 102. On the other hand, if the payment request is associated with a high value commodity and/or service, the gateway 110 may not determine the user 102 is an authenticated user unless there are multiple factors that are in favor of the user 102. If the gateway 110 can authenticate the user 102, the process 900 proceeds to step 912. If the gateway 110 cannot authenticate the user 102, the process 900 proceeds to step 920. In some embodiments, the gateway 110 updates the user's profile based on the location information and the payment request. The process 900 then proceeds to step 912.

At step 912, the gateway 110 determines a payment form, for the payment request, based on the user's profile and the payment request. In some embodiments, based on the user's profile such as the user's payment preference, the gateway 110 may choose a specific payment card/account from all of the user's available payment cards/accounts. For example, the user's profile may indicate that for any purchase in the coffee shop, a gift card from the coffee shop should be used first before resorting to other payment methods. The user's profile may further indicate that for any purchase in the coffee shop, a gratuity percentage or a fixed amount will be added to the original payment request. The process 900 then proceeds to step 914.

At step 914, the gateway 110 sends the payment form to the payment network 112. The payment network 112 can then process the payment form. The process 900 then proceeds to step 916.

At step 916, the gateway 110 receives a payment authorization from the payment network 112. In some embodiments, if the payment form does not go through, the gateway 110 will receive an error message from the payment network 112. The process 900 then proceeds to step 918.

At step 918, the gateway 110 sends the payment authorization to the merchant device 106. In the use case example, after the gateway 110 receives the payment request at step 908 regarding the cappuccino, the merchant device 106 receives the payment authorization indicating the payment request has been approved. In some embodiments, if there is an employee at the merchant device 106, the employee can notify the user 102 that his or her purchase has been approved. In some embodiments, if the merchant device 106 is an automatic check-out kiosk, the merchant device 106 may indicate that the user 102 can leave with his or her purchase since it has been approved. During the whole process 900, the user 102 generally does not need to show his or her identification and/or payment cards.

At step 920, the gateway 110 requests additional information regarding the user 102 from the merchant device 106 so that the gateway 110 can further authenticate the user 102. For example, when the gateway 110 cannot authenticate the user 102, the merchant device 106 may ask the user 102 to show his or her identification. In some embodiments, the merchant device 106 may authenticate the user 102 based on the identification and notify the gateway 110. In some embodiments, the merchant device 106 may send the user 102's identification information to the gateway 110, and the gateway 110 can further authenticate the user 102.

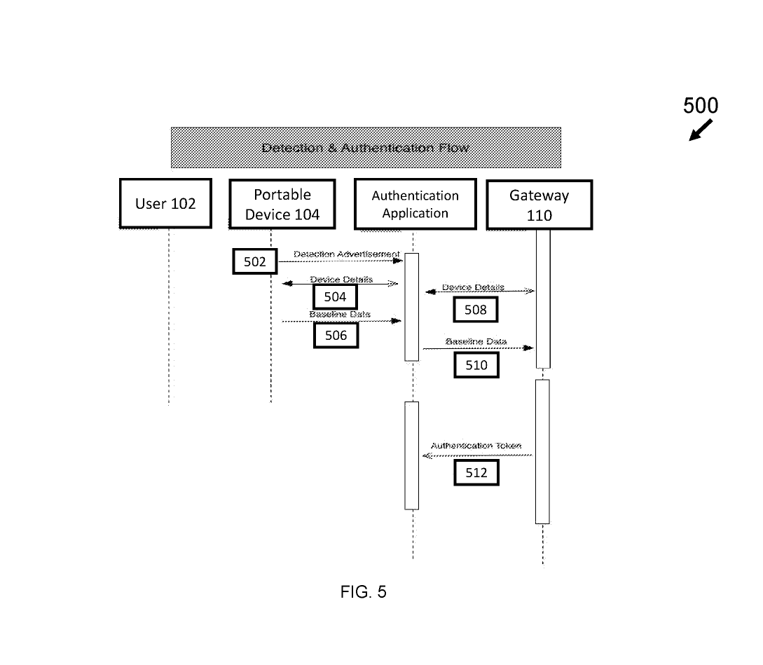

FIG. 5 illustrates a detection and authentication process 500 in accordance with an embodiment of the invention. In some embodiments, the process 500 can be modified by, for example, having steps rearranged, changed, added, and/or removed.

At step 502, the portable device 104 can advertise its presence through BLE or any other suitable communication technology. In some embodiments, the communication technology provides a communication layer between the portable device 104 and the merchant device 106. The process 500 then proceeds to step 504.

At step 504, device details of the portable device 104 can be captured by an authentication application running on a mobile or desktop system. For example, in some embodiments, the authentication application is located on the merchant device 106. As a non-limiting example, the device details can include one or more of the following digital fingerprints of the portable device 104: MAC address, the IP address, a BLE profile such as a BLE signature or a BLE serial number, and/or other suitable identifiers that can identify the portable device 104. The process 500 then proceeds to step 506.

At step 506, some additional baseline data of the portable device 104 or the user 102 can be received by the authentication application from the portable device 104 and/or the user 102. In some embodiments, the baseline data include biometric data, fitness data, other suitable information of the user's profile, any other suitable data or combination of suitable data. For example, the baseline data can be electrocardiogram readings or fingerprints of the user 102. In some embodiments, the baseline data can be used by the authentication application and/or the gateway 110 for authentication and/or payment processing. The process 500 then proceeds to steps 508 and 510.

At steps 508 and 510, the authentication application sends the device details and the baseline data received in earlier steps to the gateway 110. The process 500 then proceeds to step 512.

At step 512, the gateway 110 authenticates the portable device 104 and the user 102 based on the device details and/or the baseline data. In some embodiments, if the gateway 110 can authenticate the portable device 104 and the user 102, the gateway 110 sends an authentication token to the authentication application. In some embodiments, the authentication token is a representation of the user′ profile that is linked to payment credentials stored in the gateway.

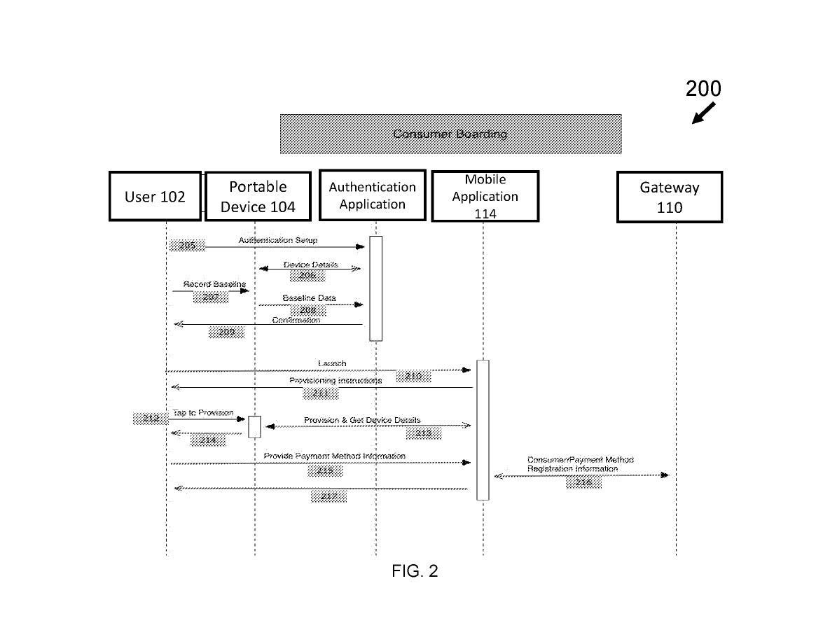

FIG. 2 illustrates a user onboarding process 200 in accordance with certain embodiments of the disclosed subject matter. In some embodiments, the process 200 can be modified by, for example, having steps rearranged, changed, added, and/or removed.

At step 205, the user 102 initiates the authentication setup using his or her portable device 104. At step 206, the authentication application discovers the portable device 104 through the advertisement protocols emitted by the portable device. The device details of the portable device 104 can be captured by the authentication application running on a mobile or desktop system. For example, in some embodiments, the authentication application is located on the merchant device 106. At step 207, the user 102 initiates authentication sequence to establish baseline setup for authentication. At step 208, the baseline data is captured by the authentication application for future authentication evaluation. At step 209, the user 102 receives a notification that the baseline setup is completed. At step 210, the user 102 launches the mobile application 114. The mobile application 114 can run on a mobile or desktop system. At step 211, if the user 102 has not been boarded on the IoTPP before, the user 102 is presented with provisioning instructions. At step 212, the user 102 puts the portable device 104 into provisioning mode. At step 213, the mobile application 114 can dynamically discover the details of the portable device 104 through suitable communication protocols such as the BLE 4.0 advertisement protocol. At step 214, the user 102 receives a notification that provisioning is completed, and the user 102 may continue with the IoTPP boarding process. At step 215, the user 102 provides details of payment methods (e.g., options and preferences of different payment accounts) that the user 102 would like to use for the IoTPP. At step 216, the gateway 110 securely stores the information of the user 102 and the payment method. At step 217, the user 102 is notified of successful boarding/registration the IoTPP system.

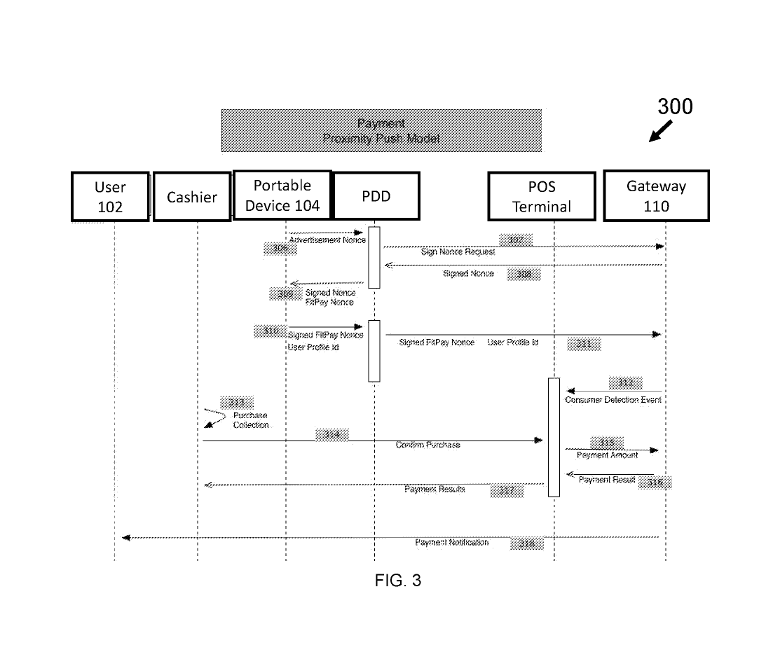

FIG. 3 illustrates a “push” process 300 for proximity detection and payment in accordance with an embodiment of the invention. In particular, FIG. 3 and the process 300 show a flow that the user 102's identity is detected, authenticated and shared with or “pushed” to the merchant device 106. Once the user 102 is confirmed, the transaction details are provided by the merchant device 106 and the payment transaction is completed. Although FIG. 3 shows that the merchant device 106 has two separate devices—the PDD and the POS terminal, in some embodiments, the PDD and the POS terminal can be integrated into a single merchant device 106. In some embodiments, the process 300 can be modified by, for example, having steps rearranged, changed, added, and/or removed.

At step 306, the portable device 104 advertises a security nonce using suitable communication protocols such as a standard Bluetooth advertisement protocol. At step 307, the PDD receives the security nonce and requests the nonce be signed by the gateway 110 using a private security key. At step 308, the securely signed nonce is returned to the PDD. At step 309, the PDD returns the signed nonce and a newly generated IoTPP nonce to the portable device 104. At step 310, the portable device 104 validates the securely signed nonce against an IoTPP public key. The portable device 104 also signs the IoTPP nonce using its locally stored private security key. The signed IoTPP nonce and user profile identification are then sent to the PDD. At step 311, the PDD sends the signed IoTPP nonce and user profile identification to the gateway 110. In some embodiments, the user profile identification can be a token of the portable device 104. At step 312, the gateway 110 notifies the POS terminal of the presence of the user 102. In some embodiments, if the merchant has more than one POS terminal, the gateway 110 can determine the POS terminal that is nearest to the user 102 based on the location information of the PDD and/or the user 102. At step 313, the cashier registers the purchase details using the POS terminal and visually confirms the user 102 using the user's profile picture. In some embodiments, the user's profile picture can be sent from the gateway 110 after retrieving the user's profile. In some embodiments, the POS terminal can receive the user's profile picture from the portable device 104. At step 314, the cashier confirms the purchase using the user's IoTPP account as the payment methods. At step 315, the POS terminal sends the payment request to the gateway 110. In some embodiments, the payment request includes a specific tender amount of the payment. At step 316, the result of the payment is returned to the POS terminal. At step 317, the result of the payment is returned to the cashier in order to complete the payment workflow (e.g., generate a receipt). At step 318, the gateway 110 notifies the user 102 through a notification preference selected by the user 102 (e.g., mobile device notification, SMS, email, etc. . . . ) that a payment using his or her IoTPP account has occurred.

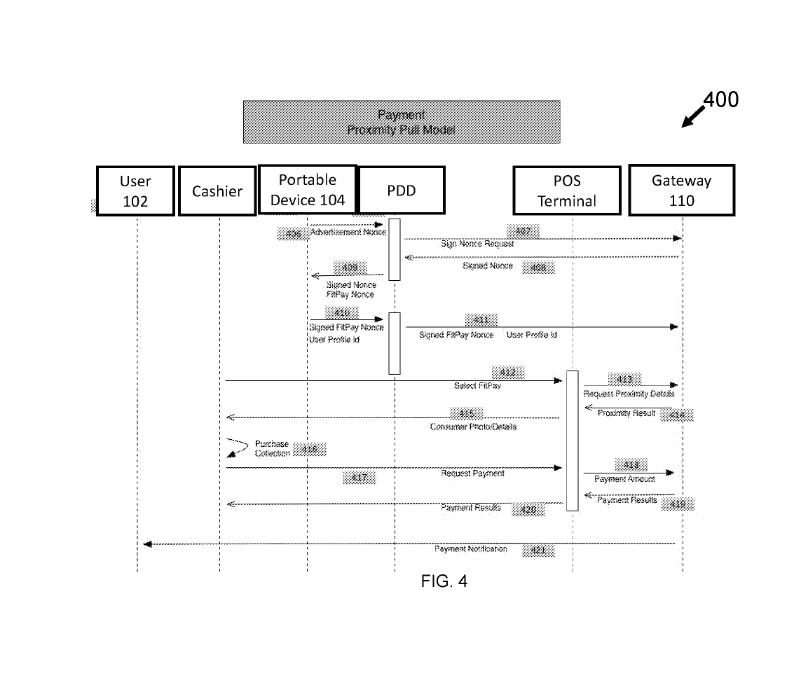

FIG. 4 illustrates a “pull” process 400 for proximity detection and payment in accordance with an embodiment of the invention. In particular, FIG. 4 and the process 400 show a flow that the user 102's identity is detected, authenticated and shared with or “pulled” from the merchant device 106. Once the user 102 is confirmed, the transaction details are provided by the merchant device 106 and the payment transaction is completed. Although FIG. 4 shows that the merchant device 106 has two separate devices—the PDD and the POS terminal, in some embodiments, the PDD and the POS terminal can be integrated into a single merchant device 106. In some embodiments, the process 400 can be modified by, for example, having steps rearranged, changed, added, and/or removed.

At step 406, the portable device 104 advertises a security nonce using suitable communication protocols such as a standard Bluetooth advertisement protocol. At step 407, the PDD receives the security nonce and requests the nonce be signed by the gateway 110 using a private security key. At step 408, the securely signed nonce is returned to the PDD. At step 409, the PDD returns the signed nonce and a newly generated IoTPP nonce to the portable device 104. At step 410, the portable device 104 validates the securely signed nonce against an IoTPP public key. The portable device 104 also signs the IoTPP nonce using its locally stored private security key. The signed IoTPP nonce and user profile identification are then sent to the PDD. At step 411, the PDD sends the signed IoTPP nonce and user profile identification to the gateway 110. In some embodiments, the user profile identification can be a token of the portable device 104. At step 412, the cashier selects IoTPP disclosed in the present application as the preferred payment method of the user 102. At step 413, the POS terminal queries the gateway 110 for the most recent proximity detection event captured in the above sequence. At step 414, the results of the proximity negotiation are returned to the POS terminal from the gateway 110. At step 415, the POS terminal presents the details of the proximity negotiation to the cashier including details like the user 102's profile picture. In some embodiments, the user's profile picture can be sent from the gateway 110 after retrieving the user's profile. In some embodiments, the POS terminal can receive the user's profile picture from the portable device 104. At step 416, the cashier registers the purchase details using the POS terminal and visually confirms the user 102 using the user's profile picture. At step 417, the cashier confirms the purchase using the user's IoTPP account as the payment methods. At step 418, the POS terminal sends the payment request to the gateway 110. In some embodiments, the payment request includes a specific tender amount of the payment. At step 419, the result of the payment is returned to the POS terminal. At step 420, the result of the payment is returned to the cashier in order to complete the payment workflow (e.g., generate a receipt). At step 421, the gateway 110 notifies the user 102 through a notification preference selected by the user 102 (e.g., mobile device notification, SMS, email, etc. . . . ) that a payment using his or her IoTPP account has occurred.

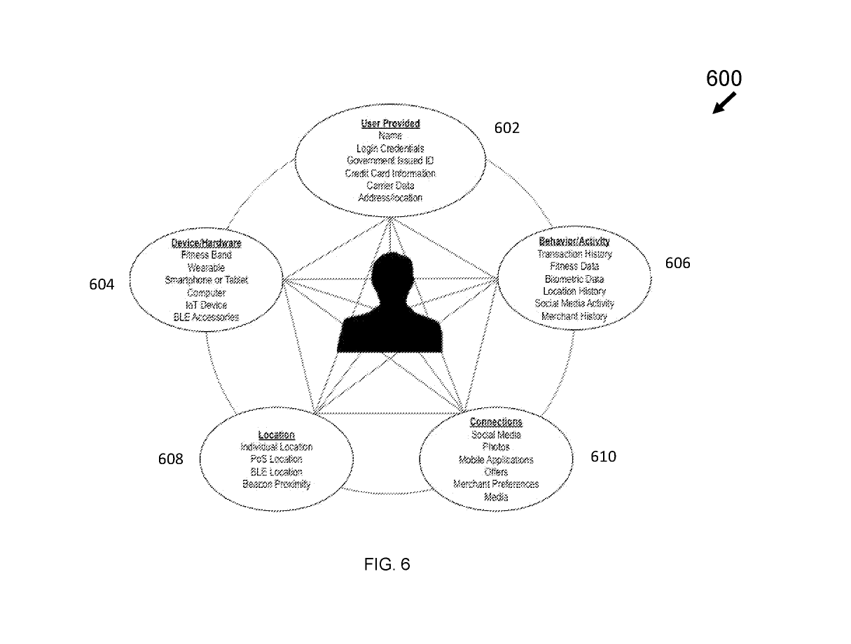

FIG. 6 illustrates a connected persona algorithm (CPA) 600 that can be used to detect, identify, and/or authenticate IoTPP users in accordance with certain embodiments of the disclosed subject matter. The CPA 600 can include one or more of the following components: the user provided information 602, the device/hardware information 604, the behavior/activity 606, the location 608, and the connections 610. The components included in the CPA 600 can be further broken down into more than one component and/or combined together in any suitable arrangement. Further, one or more components can be rearranged, changed, added, and/or removed.

The user provided information 602 is the first level of information that allows the CPA process to verify a registered user's identity. This includes information such as (but not limited to) full name of user, physical address, login credentials, mobile carrier information, government-issued identification and/or verified credit card or bank account information.

The CPA 600 includes unique data points about an individual user's behavior and activity information 604. This data includes information about a user's transaction history, fitness and biometric data, location history and patterns, social media activity, merchant history, and other online activity-based information. These data points are used by the CPA 600 to process additional validation of a user's identity. In some embodiments, the user's behavior/activity information 604 can include, for example, data pertaining to logged workouts—e.g., miles walked, ran or biked, number of steps accumulated in real-time and/or historical timeframe, average calories burned, hours of sleep per day (e.g., restful and restless). The relationship of each data point and the comparative change of the registered data can become factoring elements of the CPA. Specifically, variations of data that may indicate morphing of an individual's identity by a non-authorized user. In some embodiments, the user's behavior/activity information 604 can include the user's purchase behaviors. In some embodiments, the gateway 110 or other components of the IoTPP can obtain the user's purchase behavior information from third-parties to create a purchase behavior profile. Purchase behavior profiles can encompass location of frequented retailer by the user and the cadence of purchase activity at those retailers. For example, the user 102 visits Jamba Coffee between 8:10 am and 8:25 am three times per week. The Jamba Coffee locations most frequented reside with 5 miles of the registered residential address of the user 102. Deviations for purchase behavioral patterns may indicate the loss or illicit use of a particular portable device 104 that has been registered.

The device/hardware information 606 can include digital fingerprint of hardware devices. The CPA platform reads and identifies the unique digital fingerprint of hardware devices such as fitness bands or other wearables, smartphones, computers, tablets, BLE accessories, or other suitable IoT devices. The digital fingerprint is derived from unique digital markers that are emitted by the devices such as (but not limited to) the device's MAC address, the IP address, BLE signature or serial number, and/or other identifiers that are unique to each device.

The location information 608 is used by the CPA 600 to further verify identity of a user at a merchant location. The location information 608 includes available location information emitted by the users' device, the location of the POS terminal, any BLE devices present, BLE Beacon proximity device present in the merchant location, and/or any other suitable location information. These data points are compared by the CPA 600 to validate the user's identity and cross reference the user's location with other fixed points. These attributes are collected in real-time and compared to historical data in order to ascertain patterns and/or variation of patterns that can contributed to a user's digital identity.

Another point of reference used by the CPA 600 in validating a user is identifying the user 102's online connections 610 through social media, online photo(s), offers that have been sent to/completed by the user 102, media connections, applications present/active on the portable device 104, and/or any other suitable connection information. Commonalities in the user 102's social media connections add an additional point of reference for the algorithm. Comparative social network contacts from Facebook, Twitter, Instagram, and other social platforms can be matched against social contacts established within the IoTPP platform. Specific details related to contacts can be masked or “hashed” in order to anonymize the data in adherence with the privacy protections of the user 102. These discreet data points provide further data about a user's identity, which the algorithm uses to increase the accuracy of the validation process.

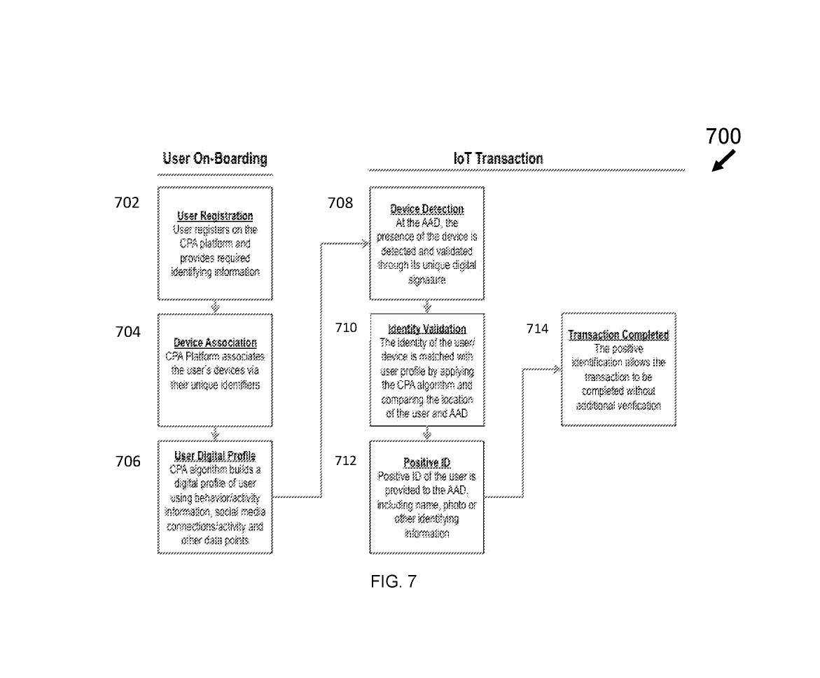

FIG. 7 shows an authentication and transaction process 700 of electronic payment through the CPA in accordance with an embodiment of the disclosed subject matter. In some embodiments, the process 700 can be modified by, for example, having steps rearranged, changed, added, and/or removed.

At step 702, the CPA begins with the on boarding of the user 102 onto the IoTPP via the user's registration. To register, the user 102 provides required identifier such as name, address, credit card, bank account information, mobile carrier data, government-issued identification and/or other suitable information. The user 102 also authorizes the use of the data and the location information by the system. The process 700 then proceeds to step 704.

At step 704, once the user 102 has registered for the service and authorized use of his/her data and location information, the CPA then detects and associates the user's portable device 104 with the user 102. This is accomplished by reading the unique identifiers, or digital fingerprint, of each portable device 104, such as (but not limited to) the device's MAC address, the IP address, the BLE signature or serial number, and/or other suitable identifiers that are unique to each portable device 104. Once associated with the user 102, the portable device 104, including its presence (or absence) and location data are used to provide information to the CPA. The process 700 then proceeds to step 706.

At step 706, as one of the final steps of the on-boarding process and throughout the time the user 102 is registered on the IoTPP, the CPA builds and maintains a digital profile of the user 102 by using behavior/activity information, social media connections/activity and other data points about the user's online activity. These data points add information that the CPA uses to authenticate the user 102 and his/her portable device 104 when they are present at a merchant POS location. The process 700 then proceeds to step 708

At step 708, at the merchant's location, the presence of the user 102 and his/her portable device 104 is detected by the merchant device 106. In some embodiments, the merchant device 106 can be a BLE beacon proximity device within the merchant's POS system and/or at the merchant's location. The portable device 104 is then validated by the CPA via the portable device 104's unique digital signature. The process 700 then proceeds to step 710.

At step 710, the identity of the user 102 and/or the portable device 104 is matched with user's profile by applying the CPA and comparing the location information of the user 102 and the physical location of the merchant POS. In some embodiments, the CPA can additionally or alternatively compare the user's profile with the payment request from the user 102 via the merchant device 106. The algorithm assesses all the relevant data points and the probability of the available associated information being present for the user 102. It then produces (or declines to produce) a positive identification of the user 102. The process 700 then proceeds to step 712.

At step 712, the validation of the identity of the user 102 is then provided to the merchant device 106. In some embodiments, the validation of the identity of the user 102 includes name, photo, and/or any other identifying information. This provides the merchant an independent visual and information reference by which it can confirm the identity of the user 102. The process 700 then proceeds to step 714.

At step 714, the positive identification allows the merchant's transaction to be completed without additional verification.

The IoTPP disclosed in the present application creates a platform to enable frictionless and secure payments using a portable device. Friction is any action a consumer needs to take to complete a transaction. For example, finding a phone or wallet, opening a mobile app, signing, tapping, or entering a PIN are all points of friction. They impede consumer convenience, do not advance security, and offer limited benefits for retailers. All current systems require some form of consumer action at the point of transaction. The uniqueness of IoTPP's platform is derived from the elimination of most or all required action during the transaction.

The IoTPP eliminates friction through a highly secure, biometrically and data-web validated payment platform. It does not require a consumer to take out a wallet or mobile device, to open an application, tap a POS machine or use a stylus to sign a screen. For merchants, the IoTPP's proximity recognition speeds transactions, increases service levels and creates customer affinity opportunities.

In addition, the IoTPP allows the consumer to fully customize their payment methods, so they can decide what method of payment to use at which retail location, use gift cards or store credits, earn affinity points, pre-authorize gratuities for restaurant locations and a range of other options.

For example, a consumer using the IoTPP walks into a restaurant that he or she has never visited, but the restaurant is a merchant that participates in the IoTPP (the merchant is also referred to as an IoTPP merchant). The IoTPP platform recognizes the guest and the employee of the restaurant is able to address him or her by name. At the table, the server confirms the consumer will be paying via IoTPP. After the meal, the consumer simply leaves the restaurant: no waiting for the bill, no calculating a tip and a total, no signing a slip of paper, and without paper receipts in his or her pocket.

By using a unique combination of the CPA, proximity detection, and integrated processing, the IoTPP brings a transformative way of conducting a payment transaction at retail locations that is far more secure than current methods. Recent high-profile data breaches have made POS security one of the biggest challenges facing the retail industry. In some embodiments, the IoTPP solves this challenge in four critical ways. First, the CPA process uniquely identifies every user and so that the user's profile cannot be duplicated or stolen.

Second, a cloud-based payment platform that eliminates POS account data sharing, greatly enhancing data security. The IoTPP deploys a unique combination of services in order to securely identify authorized users and ensure data provided from those users are not exposed to acceptance hardware. The IoTPP ensures all data will not be vulnerable to potential data breaches, infiltration of malware, or Botnet attacks.

Third, the proximity detection confirms the validated consumer is present at the location where the transaction is occurring. An attribute of IoT devices is the advertisement of device identifiers over a suitable wireless protocol such as the BLE 4.0. The IoTPP leverages this capability in order to contribute to the authentication process described in FIG. 7. This creates a propriety authentication token for the device, allowing the identity of the user to be confirmed and authorized and transactions to be processed.

Fourth, tokenized payment information protects consumer data and offers an added layer of security. A unique, encrypted data hash converts payment card data into a benign string of alphanumeric characters that can only be retrieved through the exchange of secure public/private encryption keys create by the IoTPP. The IoTPP preserves the tokens in order to submit payment transactions to the payment networks.

The IoTPP disclosed in the present application can create advanced functionality at merchant locations in the following aspects.

Beacon technology can be used at merchant locations to identify the location of consumers and provide relevant offers. IoTPP merchants can push digital POS messages directly to users' mobile devices when they are in a retail location. This proximity marketing can create a new and powerful way to engage customers. Beacon technology is a form of ambient context identification that allows the presence of an individual smart device to be recognized and identified. As a non-liming example, beacons can use BLE proximity sensing to transmit a universally unique identifier that is identified by the Platform to verify the device/user's physical location and trigger an action such as verifying the user's location/identity, cueing the user in the POS for payment and sending locations specific information/messages. The IoTPP's ability to uniquely identify consumers when they are in a retail location can provide merchants a new opportunity to increase service levels, understand and utilize consumer preferences, and facilitate easier transactions, which can increase customer satisfaction.

Because the IoTPP greatly increases the speed of transactions, IoTPP merchants can turn restaurant tables more quickly, reduce wait times at check out and increase transactions per hour. Reducing the time per transaction can have a direct and measurable impact on the bottom line for many retailers.

In addition to the functionality described above, the platform can be enhanced to significantly expand the consumer and merchant customization preferences and functionality. These enhanced capabilities can increase utility of the platform and, when combined with the ability to conduct a payment transaction, can enable the function as a combined, single platform. These enhancements can include, but are not limited to, features and functionality for consumers and merchants, such as the following non-limiting examples.

The ability to create proximity-based profiles that establish payment preferences by the consumer's physical location, allowing the consumer to select their payment option by their physical location. For example, an IoTPP user could identify a specific payment instrument to be used only at specific merchant locations or for transactions above or below specific values. The IoTPP can have predictive indicators in which the IoTPP user's behaviors are fed to a machine learning algorithm to predict the selection of payment location preferences on behalf of the users, further contributing to the convenience and personalized experience of the IoTPP system.

IoTPP users can contribute multiple payment and locality cards to their IoTPP profile. For example, the users can customize their profiles by designating different gift cards, affinity programs, loyalty rewards, store credit, and/or other payment programs/methods to different retail environment. In some embodiments, the user may opt-in to share these instruments with chosen retail acceptance locations in order to facilitate and simply to earn, track, and/or redeem merchant rewards and loyalty points.

In some embodiments, the IoTPP systems can provide detailed transaction and merchant reporting to IoTPP users. The information can allow users to see the frequency, amount, location, and category of all purchase transactions on the IoTPP system. This information can be used to help drive improved spending behaviors, cap purchase frequency for specific transaction types or merchant categories, or share purchase activity within a social network.

In some embodiments, the IoTPP users can establish automated profile trees for specific merchants or transaction types with the IoTPP acceptance network. The profiles can contribute to enhanced management of transaction types and amounts by automating how a user can seamlessly add gratuities to transaction where appropriate, limits to purchase totals, and/or allowable locations to authorize payment events.

The IoTPP system can allow users to add crypto-currencies, such as BitCoin or other suitable currencies, to their available payment types within their personal profiles. This can extend the flexibility an IoTPP user has when making purchases at IoTPP merchant locations. Acceptance of crypto-currencies is very limited at physical retail locations due to the authentication barriers of the systems and requirement to access crypto-currency wallets. The IoTPP can allow users to authorize access to their crypto-currency account for instant access during IoTPP transactions.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. In addition, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods and media for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method for electronic payment from a portable device that is associated with a user to a payment network via a merchant device and a gateway, comprising:
receiving, at the gateway from the merchant device, a first message that comprises information indicating that the portable device that is associated with the user is within a predefined distance from the merchant device, a token received from the portable device, and location information of the merchant device;
retrieving, at the gateway, a profile of the user based on the token received from the portable device, wherein the user's profile comprises a picture of the user;
sending, at the gateway to the merchant device, a second message that comprises information indicating that the user is within the predefined distance from the merchant device, and the picture of the user for authentication;
receiving, at the gateway from the merchant device, a payment request that is associated with the user;
determining, at the gateway, if an identity of the user can be authenticated based on the user's profile and at least one of the location information or the payment request; and
when the user's identity can be authenticated:
determining, at the gateway, a payment form for the payment request that is determined based on the user's profile and the payment request,
sending, at the gateway to the payment network, the payment form,
receiving, at the gateway from the payment network, a payment authorization, and
sending, at the gateway to the merchant device, the payment authorization.

2. The method of claim 1, further comprising updating, at the gateway, the user's profile based on the location information and the payment request.

3. The method of claim 1, wherein when the user's identity cannot be authenticated, further comprising requesting, at the gateway to the merchant device, additional information regarding the user.

4. The method of claim 1, wherein the token comprises at least one of a one of a media access control (MAC) address, an internet protocol (IP) address, or a Bluetooth Low Energy (BLE) profile.

5. The method of claim 1, wherein the user's profile comprises at least one of a one of a payment preference, transaction history, location history, social media activity, merchant history, or a purchase behavior.

6. The method of claim 1, wherein the user's profile comprises at least one of fitness data or biometric data.

7. An apparatus for facilitating electronic payment from a portable device that is associated with a user to a payment network via a merchant device, the apparatus comprising:
a memory that stores a module; and
a processor configured to run the module stored in the memory that is configured to cause the processor to:
receive, from the merchant device, a first message that comprises information indicating that the portable device that is associated with the user is within a predefined distance from the merchant device, a token received from the portable device, and location information of the merchant device,
retrieve a profile of the user based on the token received from the portable device, wherein the user's profile comprises a picture of the user,
send, to the merchant device, a second message that comprises information indicating that the user is within the predefined distance from the merchant device, and the picture of the user for authentication,
receive, from the merchant device, a payment request that is associated with the user,
determine if an identity of the user can be authenticated based on the user's profile and at least one of the location information or the payment request, and
when the user's identity can be authenticated:
determine a payment form for the payment request that is determined based on the user's profile and the payment request,
send, to the payment network, the payment form,
receive, from the payment network, a payment authorization, and
send, to the merchant device, the payment authorization.

8. The apparatus of claim 7, wherein the module is further configured to update the user's profile based on the location information and the payment request.

9. The apparatus of claim 7, wherein when the user's identity cannot be authenticated, the module is further configured to request, to the merchant device, additional information regarding the user.

10. The apparatus of claim 7, wherein the token comprises at least one of a one of a media access control (MAC) address, an internet protocol (IP) address, or a Bluetooth Low Energy (BLE) profile.

11. The apparatus of claim 7, wherein the user's profile comprises at least one of a one of a payment preference, transaction history, location history, social media activity, merchant history, or a purchase behavior.

12. The apparatus of claim 7, wherein the user's profile comprises at least one of fitness data or biometric data.

13. The apparatus of claim 7, wherein the merchant device comprises:
a proximity detection device configured to detect that the portable device is within the predefined distance from the proximity detection device; and
a point of sale terminal configured to receive the payment request that is associated with the user,
wherein the proximity detection device and the point of sale terminal are separate devices.

14. The apparatus of claim 7, wherein the merchant device comprises:
a proximity detection device configured to detect that the portable device is within the predefined distance from the proximity detection device; and
a point of sale terminal configured to receive the payment request that is associated with the user,
wherein the proximity detection device and the point of sale terminal are integrated into a single device.

15. The apparatus of claim 7, wherein the portable device is a wearable device.

16. A non-transitory computer readable medium having executable instructions operable to cause an apparatus to:
receive, from a merchant device, a first message that comprises information indicating that a portable device that is associated with a user is within a predefined distance from the merchant device, a token received from the portable device, and location information of the merchant device;
retrieve a profile of the user based on the token received from the portable device, wherein the user's profile comprises a picture of the user;
send, to the merchant device, a second message that comprises information indicating that the user is within the predefined distance from the merchant device, and the picture of the user for authentication;
receive, from the merchant device, a payment request that is associated with the user;
determine if an identity of the user can be authenticated based on the user's profile and at least one of the location information or the payment request; and
when the user's identity can be authenticated:
determine a payment form for the payment request that is determined based on the user's profile and the payment request,
send, to a payment network, the payment form,
receive, from the payment network, a payment authorization, and
send, to the merchant device, the payment authorization.

17. The non-transitory computer readable medium of claim 16, wherein the executable instructions are further configured to update the user's profile based on the location information and the payment request.

18. The non-transitory computer readable medium of claim 16, wherein when the user's identity cannot be authenticated, the executable instructions are further configured to request, to the merchant device, additional information regarding the user.

19. The non-transitory computer readable medium of claim 16, wherein the user's profile comprises at least one of a payment preference, transaction history, location history, social media activity, merchant history, or a purchase behavior.

20. The non-transitory computer readable medium of claim 16, wherein the user's profile comprises at least one of fitness data or biometric data.
